(19) United States
(12) Patent Application Publication
(10) Pub. No.: US 2024/0007584 A1
(43) Pub. Date: Jan. 4, 2024

(54) METHOD FOR SELECTING PORTIONS OF IMAGES IN A VIDEO STREAM AND SYSTEM IMPLEMENTING THE METHOD

(71) Applicant: SAGEMCOM BROADBAND SAS, Rueil Malmaison (FR)

(72) Inventors: Jad Abdul Rahman OBEID, Rueil Malmaison (FR); Jérôme BERGER, Rueil Malmaison (FR)

(73) Assignee: SAGEMCOM BROADBAND SAS, Rueil Malmaison (FR)

(21) Appl. No.: 18/214,115

(22) Filed: Jun. 26, 2023

(30) Foreign Application Priority Data
Jun. 29, 2022 (FR) 2206559

(51) Int. Cl. H04N 5/262

(52) U.S. Cl. CPC H04N 5/2628

(57) ABSTRACT

A method for selecting portions of images from a video stream including a representation of a subject, the method including the steps of determining a first portion of an image including the subject, determining a target zoom factor among a plurality of zoom factors from the limits determined, a current zoom factor and at least one maximum image resolution and determining target coordinates of the first portion of an image reframed according to the target zoom factor determined and a maximum image resolution.

### TECHNICAL FIELD

The present invention relates to the processing of a video stream of a videoconference application and to the selection of portions of images to be reproduced on a device for reproducing the video stream. The invention relates more precisely to a method for improved framing of one or more speakers during a videoconference.

### PRIOR ART

Techniques for monitoring one or more speakers filmed by a videoconference system exist. These techniques implement a reframing of the image according to the position of the speaker being filmed, for example when the latter moves in the environment, in the field of the camera. It frequently happens, however, that the automatic framing thus implemented causes abrupt changes in the image during display, including in particular jerks causing an impression of robotic movement of the subject or subjects, of such a nature as to make viewing unpleasant. In fact the framing implemented follows the user while reproducing a movement at constant speed. These artefacts are generally related to unpredictable events relating to the techniques for detecting one or more subjects, applied to a video stream. The situation can be improved.

### DISCLOSURE OF THE INVENTION

The aim of the invention is to improve the rendition of a subject during a videoconference by implementing an improved reframing of the subject in a video stream with a view to reproducing this video stream on a display device.

For this purpose, the object of the invention is a method for selecting portions of images to be reproduced, from a video stream comprising a plurality of images each comprising a representation of the subject, the method comprising the steps of:
determining limits of a first portion of an image comprising said subject,
determining a target zoom factor among a plurality of zoom factors from said limits, a current zoom factor and at least one maximum resolution of said images,
determining target coordinates of a second portion of an image, representing the subject, obtained from the first portion of an image, by a reframing implemented according to the target zoom factor determined and said at least one maximum resolution.

Advantageously, it is thus possible to avoid jerk and shake effects during the reproduction of a portion of an image illustrating at least one speaker, after reframing, during a videoconference.

Advantageously, the method for selecting portions of an image furthermore comprises, subsequently to the step of determining target coordinates:
a determination of display coordinates of the second portion of an image from said target coordinates and prior display coordinates used for a display of a third portion of an image on a display, and
a display of the second portion of an image on the display.

The method according to the invention may also comprise the following features, considered alone or in combination:
The determination of limits of the first portion of an image comprises a time filtering implemented using a plurality of images of the video stream.
The determination of display coordinates of a second portion of an image comprises a time filtering implemented using a plurality of prior display coordinates used for a display of portions of images.
The determination of a target zoom factor is implemented using a hysteresis mechanism.
The method further comprises a use of a plurality of second zoom factors and comprises a modification of at least one of the second zoom factors in the plurality of second zoom factors according to at least the target zoom factor determined.
The modification of at least one of the second zoom factors uses a method for modifying a series of data according to a variant of the so-called “Adaptive Neural Gas” algorithm.

Another object of the invention is a system for selecting portions of images comprising an interface for receiving a video stream comprising a plurality of images each comprising a representation of a subject, and electronic circuits configured to:
determine limits of a first portion of an image comprising the subject,
determine a target zoom factor among a plurality of zoom factors from the limits determined, from a current zoom factor and from at least one maximum resolution of images,
determine target coordinates of the first portion of an image reframed according to the target zoom factor determined and at least one image resolution.

According to one embodiment, the system for selecting portions of images further comprises electronic circuits configured to:
determine display coordinates of a second portion of an image, representing the subject, obtained by a reframing implemented according to the target zoom factor, target coordinates and prior display coordinates used for a display of a third portion of an image on a display, and
displaying the second portion of an image on the display.

The invention furthermore relates to a videoconference system comprising a system for selecting portions of images as previously described.

Finally, the invention relates to a computer program comprising program code instructions for performing the steps of the method described when the program is executed by a processor, and an information storage medium comprising such a computer program product.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically successive images of a video stream generated by an image capture device;

FIG. 2 illustrates operations of detecting a subject in the images of the video stream already illustrated on FIG. 1.

FIG. 3 illustrates an image display device configured for the videoconference;

FIG. 4 illustrates schematically a portion of an image extracted from the video stream illustrated on FIG. 1 shown on a display of the display device of FIG. 3;

FIG. 5 illustrates schematically an image reframing for reproducing the portion of an image shown on FIG. 4, with a zoom factor, on the display of the display device of FIG. 3;

FIG. 6 is a flow diagram illustrating steps of a method for displaying a portion of an image, with reframing, according to one embodiment;

FIG. 7 illustrates schematically a global architecture of a device or of a system configured for implementing the method illustrated on FIG. 6; and

FIG. 8 is a flow diagram illustrating steps of selecting a zoom factor according to one embodiment.

### DETAILED DISCLOSURE OF EMBODIMENTS

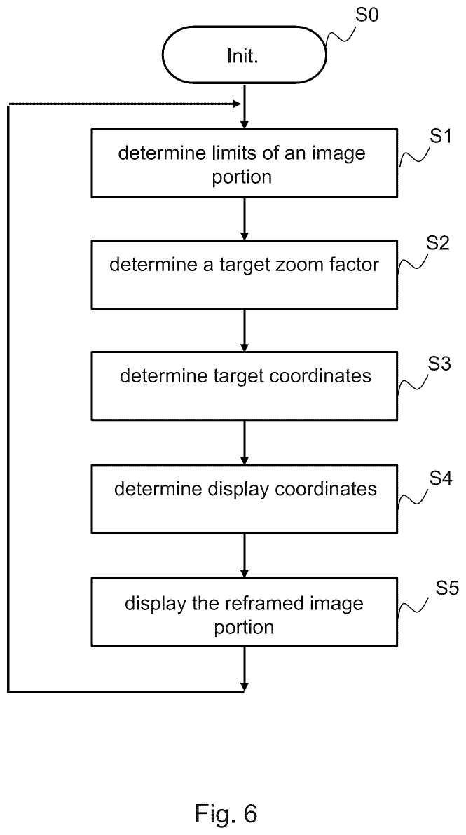

The method for selecting portions of images with a view to a display that is the object of the invention makes it possible to implement an automated and optimised framing of a subject (for example a speaker) during a videoconference session. The method comprises steps illustrated on FIG. 6 and the detailed below in the description paragraphs in relation to FIG. 6. FIG. 1 to FIG. 5 illustrate globally some of these steps to facilitate understanding thereof.

FIG. 1 illustrates schematically a portion of a video stream 1 comprising a succession of images. For purposes of simplification, only three images 12, 14 and 16 are shown, although the stream comprises a large number of successive images, among which are the successive images 12, 14 and 16. According to one embodiment, the video stream 1 is generated by an image capture device, such as a camera operating at a capture rate of 30 images per second. Obviously this example is not limitative and the video stream 1 could be generated by a device operating at another image capture frequency, such as 25 images per second or 60 images per second. The video stream 1 as shown on FIG. 1 is an outline illustration aimed at affording a rapid understanding of the display method according to the invention. Obviously the images 12, 14 and 16 are in practice encoded in the font of a series of data resulting from an encoding process according to a dedicated format and the video stream 1 comprises numerous items of information aimed at describing the organisation of these data in the video stream 1, including from a time point of view, as well as information useful to the decoding thereof and to the reproduction thereof by a decoding and reproduction device. In the present description, the terms “display” and “reproduction” both designate reproducing the video stream, reframed or not, on a display device. The video stream 1 may further comprise audio data, representing a sound environment, synchronised with the video data. Such audio data are not described here since the display method described does not relate to the sound reproduction, but only the video reproduction. According to one embodiment, each of the images 12, 14 and 16 of the video stream 1 has a horizontal resolution XC and a vertical resolution YC and comprises elements representing a subject 100, i.e. a user of a videoconference system that implemented the capture of the images 12, 14 and 16, as well as any previous images present in the video stream 1. According to one embodiment, the resolution of the images of the video stream 1 is 720×576; i.e. XC=72.0 and YC=576. This example is not limitative and the images 12, 14 and 16 could just as well comprise elements representing a plurality of subjects present in the capture field of the capture device of the videoconference system. Furthermore, the resolution of the images produced by the capture device could be different from the one according to the example embodiment.

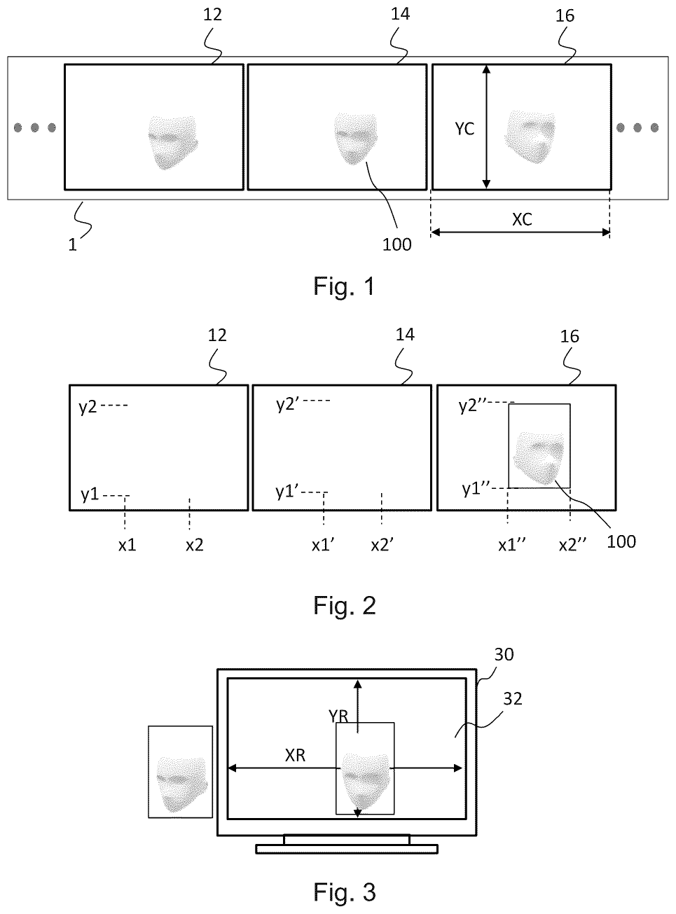

FIG. 2 illustrates a result of an automatic detection step aimed at determining the limits of a first portion of an image of the video stream 1 comprising a subject 100 filmed by an image capture device during a videoconference session.

According to the example described, an automatic detection module implements, from the video stream 1 comprising a succession of images illustrating the subject 100, a detection of a zone of the image comprising and delimiting the subject 100 for each of the images of the video stream 1. In other words, it is a case of a function of automatic subject detection from a video stream operating from the video stream 1.

According to the example described, only the face of the subject and the top of their chest are visible in the field of the camera used and the subject is therefore here illustrated by their face. This example is not limitative and the detection of the subject could implement a detection of the person as a whole, or of the entire visible part of the person (the upper half of their body when they are sitting at a desk, for example). According to another example of a variant, and as already indicated, the detection could apply to a plurality of persons present in the field of the camera. According to this variant, the subject detected then comprises said plurality of persons detected. In other words, if a plurality of persons are detected in an image of the video stream 1, they can be treated as a single subject for the subsequent operations.

According to one embodiment, the detection of the subject is implemented by executing an object detection algorithm using a so-called machine learning technique using a neural network, such as the DeepLabV3 neural network or the BlazeFace neural network, or an algorithm implementing the Viola-Jones method. According to the example illustrated, at least one zone of the “bounding box” type comprising the subject 100 is thus defined for each of the images 12, 14 and 16 and such a bounding box is defined by coordinates x (on the X-axis) and y (on the Y-axis) of one of its diagonals. Thus, for example, a bounding box defined by points of respective coordinates x1, y1 and x2, y2 is determined for the image 12. In a similar manner, a bounding box defined by points of respective coordinates x1′, y1′ and x2′, y2′ is determined for the image 14 and a bounding box defined by points of respective coordinates x1″, y1Δ and x2Δ, y2″ is determined for the image 16. There again, the example described is not limitative, and some systems or modules for automatic subject detection in an image have several bounding boxes per image, which are then as many bounding-box propositions that are potentially relevant for locating a subject of interest detected in the image concerned. In the latter case, a “resultant” or “final” bounding box is determined so as to comprise all the bounding boxes proposed, while being as small as possible. For example, in the case where two bounding boxes are presented at the output of the subject detection module, for a given image, it is possible to retain the smaller X-axis coordinate among the two X-axis coordinates and the smaller among the two Y-axis coordinates for defining the coordinates of a first point of the diagonal of the resultant bounding box. In a similar manner, it is possible to retain the larger coordinate among the two X-axis coordinates and the larger coordinate among the two Y-axis coordinates for defining the coordinates of a second point of the diagonal of the resultant bounding box. This thus gives the case where a single bounding box, referred to as “final bounding box” or “resultant bounding box” is to be considered for the subsequent operations.

According to one embodiment, the limits of a portion of an image comprising the subject 100 are determined from the coordinates of the two points of the diagonal of the bounding box determined for this image. For example, the limits of the portion of an image comprising the subject 100 in the image 16 are determined by the points of respective coordinates x1″, y1″ and x2″, y2″. According to a variant, and for the purpose of eliminating any detection errors, a time filtering is implemented using the coordinates of bounding boxes of several successive images. For example, bounding-box coordinates of the image 16, and therefore of a portion of an image containing the subject 100 as present in the image 16, are determined from the coordinates of the points defining a bounding-box diagonal for the last three images, in this case the images 12, 14 and 16. This example is not limitative.

According to a preferred embodiment, a filtering of the coordinates of the bounding box considered for the remainder of the processing operations is implemented so that a filtered coordinate Y′ of a reference point of a bounding box is defined using the same value Y of coordinates of the bounding box of the previous image, in accordance with the formula:

Yᵢ=Yᵢ₋₁−α(Yᵢ₋₁−Zi) with Z₀=Y₀

where α is a smoothing coefficient defined empirically,
Yᵢ is the smoothed (filtered) value at the instant i,
Yᵢ₋₁ is the smoothed (filtered) value at the instant i−1,
Zᵢ is the value output from the neural network at the instant i,
in accordance with a smoothing technique conventionally referred to as “exponential smoothing”.

Such a filtering is applied to each of the coordinates x1, y1, x2 and y2 of a bounding box. An empirical method for smoothing and predicting chronological data affected by unpredictable events is therefore applied to the coordinates of the bounding box. Each data item is smoothed successively starting from the initial value, giving to the past observations a weight decreasing exponentially with their anteriority.

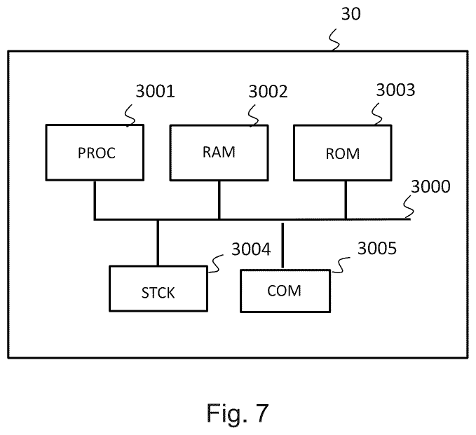

FIG. 3 shows an image display device 30, also commonly referred to as a reproduction device, configured to reproduce a video stream captured by an image capture device, and comprising a display control module configured to implement an optimised display method comprising a method for selecting portions of images according to the invention. The image display device 30, also referred to here as a display device 30, comprises an input interface for receiving a digital video stream such as the video stream 1, and a control and processing unit (detailed on FIG. 7) and a display 32 having a resolution XR×YR. According to the example described, the number of display elements (or pixels) disposed horizontally is 1900 (i.e. XR=1900) and the number of display elements (or pixels) disposed vertically is 1080 (i.e. YR=1080). In other words, the display 32 is a matrix of pixels of dimensions 1900×1080 for which each of the pixels P_{xy} can be referenced by its position expressed in coordinates x, y (X-axis between 1 and 1900 and Y-axis between 1 and 1080). As a result a portion of an image comprising the subject 100 of an image of the video stream 1, said stream comprising images of resolution XC×YC, with XC<XR and YC<YR, can in many cases be displayed after magnification on the display 32. The portion of an image extracted from the video stream is then displayed on the display 32 after reframing since the dimensions and proportions of the portion of an image extracted from the video stream 1 and that of the display 32 are not identical. The term “reframing” designates here a reframing of the “cropping” type, i.e. after cropping of an original image of the video stream 1 so as to keep only the part that can be displayed over the entire useful surface of the display 32 during a videoconference. It should be noted that the useful surface of the display 32 made available during a videoconference may be a subset of the surface actually and physically available on the display 32. This is because screen portions of the display 32 may be reserved for the display of contextual menus or of various graphical elements included in a user interface (buttons, scroll-down menus, view of a document, etc).

According to one embodiment, the method for selecting portions of an image is not included in a reproduction device such as the reproduction device 30, and operates in a dedicated device or system, using the video stream 1, which does not process the reproduction strictly speaking of the portions of images selected, but implements only a transmission or a recording in a buffer memory with a view to subsequent processing. According to one embodiment, such a processing device is integrated in a camera configured for capturing images with a view to a videoconference.

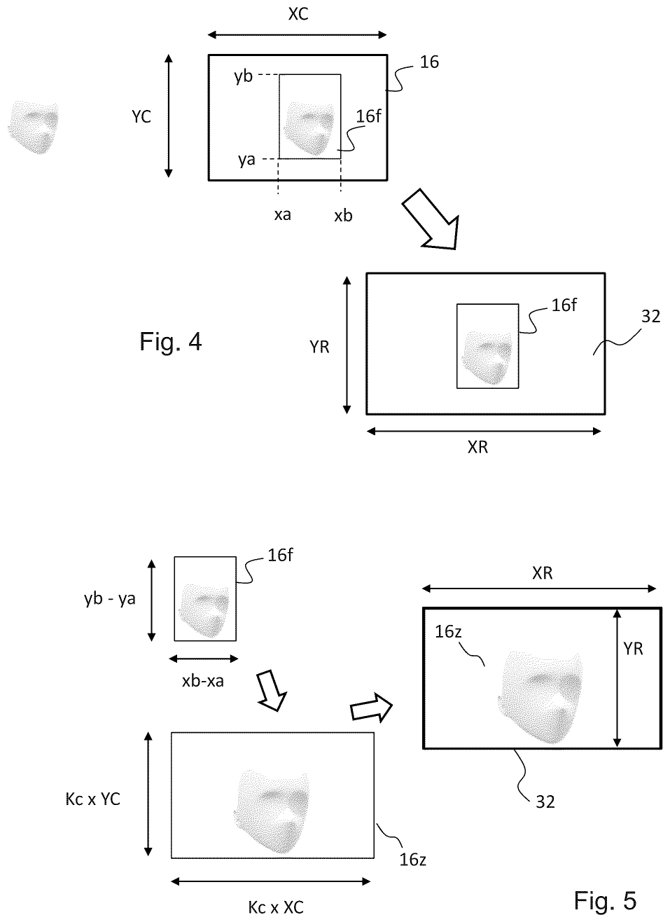

FIG. 4 illustrates schematically a determination of a portion 16 of the image 16 of the video stream 1, delimited by limits referenced by two points of coordinates xa, ya and xb, yb. As already indicated, the coordinates xa, ya, xb and yb can be defined from coordinates of a bounding box of a given image or from respective coordinates of a plurality of bounding boxes determined for a plurality of successive images of the video stream 1 or of a plurality of bounding boxes determined for each of the images of the video stream 1, to which an exponential smoothing is applied as previously described.

The top part of FIG. 4 illustrates the portion 16f (containing the subject 100) as determined in the image 16 of the video stream 1 and the bottom part of FIG. 4 illustrates the same portion 16f (containing the subject 100) displayed on the display 32, the resolution (XR×YR) of which is for example greater than the resolution (XC×YC) of the images of the video stream 1.

It can be noted that, whatever the size ratio between a native image of the video stream 1, of resolution XC, YC, and a display device of resolution XR, YR, a selected portion of interest of an image comprising a subject of image has essentially a dimension less than the maximum dimensions XC, YC of the original image, and that a zoom function can then be introduced by selecting a selected portion of image of interest (“cropping”) and then by putting to the same scale XC, YC as the original image of the portion of an image selected (“upscaling”).

According to one embodiment, the determination of a portion of an image of interest in an image is implemented so that the portion of an image of interest, determined by target coordinates xta, yta, xtb and ytb, has dimensions the ratio of which (width/height) is identical to the dimensions of the native image (XC, YC) in which this portion of an image is determined, and then this portion is used for replacing the native image from which it is extracted in the video stream 1 or in a secondary video stream produced from the video stream 1 by making such replacements.

According to one embodiment of the invention, a determination of a zoom factor is implemented for each of the successive images of the video stream 1, which consists of determining the dimensions and the target coordinates xta, yta, xtb and ytb of a portion of an image selected, so that this portion of an image has proportions identical to the native image from which it is extracted (and the dimensions of which are XC, YC) and in which the single bounding box determined, or the final bounding box determined, is ideally centred (if possible), or by default in which the bounding box is the most centred possible, horizontally and/or vertically. Thus, for example, a portion of an image is selected by cropping a portion of an image of dimensions 0.5 XC, 0.5 YC when the zoom factor determined is 0.5. According to the same reasoning, a portion of an image is selected by cropping a portion of an image of dimensions 0.75 XC, 0.75 YC when the zoom factor determined is 0.75. In the same manner again, a portion of an image is selected by considering the entire native image of dimensions XC, YC when the zoom factor determined is 1, i.e., having regard to the dimensions of the bounding box, performing cropping and upscaling operations is not required.

The term cropping means, in the present description, a selection of a portion of an image in a native image, giving rise to a new image, and the term upscaling designates the scaling of this new image obtained by “cropping” a portion of interest of a native image and putting to a new scale, such as, for example, to the dimensions of the native image or optionally subsequently to other dimensions according to the display perspectives envisaged.

According to one embodiment, a magnification factor, also referred to as a target zoom factor Kc, a use of which is illustrated on FIG. 5, is determined by selecting a zoom factor from a plurality of predefined zoom factors K1, K2, K3 and K4. According to one embodiment, and as already described, the target zoom factor Kc is between 0 and 1. This means for example that, in the case where the result of the subtraction yb−ya is larger than the result of the subtraction xb−xa, and therefore that the subject 100 has a general shape that is rather vertical and horizontal in an image of the video stream 1, a target zoom factor Kc corresponds to an enlargement of the portion of an image 16f allowing an upscaling to the native image format XR×YR is applicable. Thus, according to one example, predefined zoom factors are, for example: K1=0.25; K2=0.50; K3=0.75 et K4=1. It is then possible to determine a portion of an image to be selected with a view to a cropping operation having dimensions Kc×XC, Kc×YC and then to implement a scaling to regain a native format XC×YC or subsequently a display format XR×YR on the reproduction device 32 for example.

According to one embodiment, it is furthermore possible to determine target coordinates of the image portion 16f of the image 16 on the display 32, according to display preferences, or in other words to perform upscaling operations in relation to characteristics of the display used. For example, target coordinates xta, yta, xtb and ytb can be determined for the purpose of centring the portion of an image 16f containing the subject 100 on the useful surface of an intermediate image or of the display 32. Target coordinates of the low and high points of an oblique diagonal of the portion 16f of the image 16 on the display 32 are for example xta, yta and xtb, ytb.

According to one embodiment, the target coordinates xta, yta, xtb and ytb are determined from the coordinates xa, xb, ya, yb, from the dimensions XC, YC and from the target zoom factor Kc in accordance with the following formulae:

xta=(xa+xb−Kc×XC)/2;

xtb=(xa+xb−Kc×XC)/2;

yta=(ya+yb−Kc×YC)/2;

ytb=(ya+yb−Kc×YC)/2;

with 0≤xta≤xtb≤Kc×Xc and 0≤yta≤ytb≤Kc×Yc.

Advantageously, according to one embodiment, the target zoom factor Kc determined is compared with predefined thresholds so as to create a hysteresis mechanism. It is then necessary to consider the current value of the zoom factor with which a current reframing is implemented and to see whether conditions of change of the target zoom factor Kc are satisfied, with regard to the hysteresis thresholds, to change the zoom factor (go from the current zoom factor to the target zoom factor Kc).

According to one example, to pass for example from the zoom factor K3=0.75 to the zoom factor K2=0.50, it is necessary for the height of the bounding box that defines the limits of the portion of an image 16f to be less than or equal to the product YR×K2 from which a threshold referred to as “vertical threshold” Kh is subtracted, and for the width of this bounding box to be less than or equal to XR×K2 from which a threshold referred to as “horizontal threshold” Kw is subtracted. The thresholds Kh and Kw are here called hysteresis thresholds. According to one embodiment, a single threshold K is defined so that K=Kh=Kw=90 (expressed as a number of display pixels).

On the other hand, to pass for example from the zoom factor K2=0.5 to the zoom factor K3=0.75, it is necessary for the height of the bounding box in question to be greater than or equal to YR×K2 to which the threshold. Kh is added, or for the width of this bounding box to be less than or equal to the product YR×K2 to which the threshold Kw is added. Cleverly, a new filtering is implemented on the target coordinates obtained of the portion of an image to be selected (by a cropping operation), so as to smooth the movement of the subject according to the portions of an image successively displayed.

According to one embodiment, this filtering of the target coordinates of the portion of an image to be cropped is implemented in accordance with the same method as the gradual filtering previously implemented on each of the coordinates of reference points of the bounding box. That is to say by applying the formula:

Y′ᵢ=Y′ᵢ₋₁−α(Y′ᵢ₋₁˜Z′i) with Z′₀=Y′₀

where α is a smoothing coefficient defined empirically,
Y₁ is the smoothed (filtered) value at the instant i,
Yᵢ₋₁ is the smoothed (filtered) value at the instant i−1,
Z′ᵢ is the value of a target coordinate determined at the instant i.

Advantageously, and to limit “vibration” or “shake” effects during reproduction, if the differences between the previous target coordinates and the newly defined target coordinates of the portion of an image to be selected are below a predetermined threshold, then the newly determined target coordinates are rejected and a portion of an image is selected with a view to a cropping operation with the target coordinates previously defined and already used.

Advantageously, the method for selecting a portion of an image thus implemented makes it possible to avoid or to substantially limit the pumping effects and to produce a fluidity effect despite zoom factor changes.

According to one embodiment, all the operations described above are performed for each of the successive images of the video stream 1 captured.

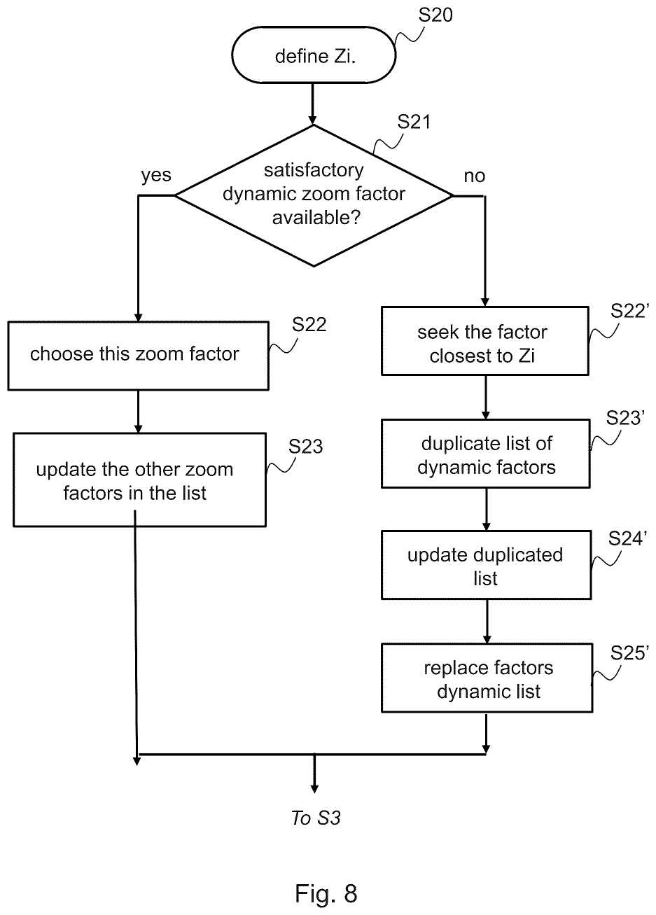

According to a variant embodiment, the target zoom factor Kc is not selected solely from the predefined zoom factors (K1 to K4 in the example described) and other zoom factors, K1′, K2′, K3′ and K4′ adjustable dynamically, are used so as to select a target zoom factor Kc from a plurality of zoom factors K1′, K2′, K3′ and K4′, in addition to the zoom factors K1 to K4, and the initial values of which are respectively K1 to K4 and which potentially change after each new determination of a target zoom factor Kc. According to one embodiment, the dynamic adaptation of the zoom factors uses a method for adjusting a series of data such as the so-called “adaptive neural gas” method or one of the variants thereof. This adjustment method is detailed below, in the descriptive part in relation to FIG. 8.

FIG. 6 illustrates a method for selecting portions of an image incorporated in an optimised display method implementing a reframing of the subject 100 of a user of a videoconference system by the display device 30 comprising the display 32.

A step S0 constitutes an initial step at the end of which all the circuits of the display device 30 are normally initialised and operational, for example after a powering up of the device 30, At the end of this step S0, the device 30 is configured for receiving a video stream coming from a capture device, such as a videoconference tool. According to the example described, the display device 30 receives the video stream 1 comprising a succession of images at the rate of 30 images per second, including the images 12, 14 and 16. In a step S1, a module for analysing and detecting objects internal to the display device 30 implements, for each of the images of the video stream 1, a subject detection. According to the example described, the module uses an object-detection technique wherein the object to be detected is a subject (a person) and supplies the coordinates xa, ya and xb, yb of points of the diagonal of a bounding box in which the subject is present. Thus, if the stream comprises a representation of the subject 100, the determination of the limits of a portion of an image comprising this representation of the subject 100 is made and the subject 100 is included in a rectangular (or square) portion of an image the bottom left-hand corner of which has the coordinates xa, ya (X-axis coordinate and Y-axis coordinate in the reference frame of the image) and the top right-hand corner has the coordinates xb, yb (X-axis coordinate and Y-axis coordinate in the reference frame of the image). According to one embodiment, if an image comprises a plurality of subjects, then a bounding box is determined for each of the subjects and a processing is implemented on all the hounding boxes to define a final so-called “resultant” bounding box that comprises all the bounding boxes determined for this image (for example, the box corner furthest to the left-hand bottom and the box corner furthest to the right-hand top are adopted as points defining a diagonal of the final bounding box).

According to one embodiment, the module for detecting objects (here subjects) comprises a software or hardware implementation of a deep artificial neural network or a network of the DCNN (“deep convolutional neural network”) type. Such a DCNN module may consist of a set of many artificial neurones, of the convolutional type or perceptron type, and organised by successive layers connected together. Such a DCNN module is conventionally based on a simplistic model of the operation of a human brain where numerous biological neurones are connected together by axons.

For example, a so-called YOLOv4 module (the acronym for «You Only Look Once version 4») is a module of the DCNN type that makes it possible to detect objects in images, and said to be “one stage”, i.e. the architecture of which is composed of a single module of combined propositions of rectangles framing objects (“bounding boxes”) and of classes of objects in the image. In addition to the artificial neurones previously described, YOLOv4 uses functions known to persons skilled in the art such as for example batch normalisation, dropblock regularisation, weighted residual connections or a non-maximum suppression step that eliminates the redundant propositions of objects detected.

According to one embodiment, the subject detection module has the possibility of predicting a list of subjects present in the images of the video stream 1 by providing, fur each subject, a rectangle framing the object in the form of coordinates of points defining the rectangle in the image, the type or class of the object from a predefined list of classes defined during a learning phase, and a detection score representing a degree of confidence in the detection thus implemented. A target zoom factor is then defined for each of the images of the video stream 1, such as the image 16, in a step S2, from the current zoom factor, the dimensions (limits) of the bounding box comprising a representation of the subject 100, and from the resolution XC×YC of the native images (of the video stream 1). Advantageously, the determination of the target zoom factor uses a hysteresis mechanism previously described for preventing visual hunting phenomena during the reproduction of the reframed video stream. The hysteresis mechanism uses the thresholds Kw and Kh, or a single threshold K=Kh=Kw. It is then possible to determine, in a step S3, target coordinates xta, yta, xtb and ytb, which define the points of the portion of an image delimited by a bounding box, after reframing, and using the target zoom factor determined. According to one embodiment, the target coordinates are defined for implementing a centring of the portion of an image containing the representation of the subject 100 in an intermediate image, with a view to reproduction on the display 32. These target coordinates xta, yta, xtb and ytb are in practice coordinates towards which the display of the reframed portion of an image 16z must tend by means of the target zoom factor Kc. Cleverly, final display coordinates xtar, ytar, xtbr and ytbr are determined in a step S4 by proceeding with a time filtering of the target coordinates obtained, i.e. by taking account of the display coordinates xtar′, ytar′, xtbr′ and ytbr′ used for previous images (and therefore previous reframed portions of images) in the video stream 1; i.e. for displaying portions of images or of the video stream 1 reframed in accordance with the same method, on the display 32. According to one embodiment of the invention, a curved “trajectory” is determined that, for each of the coordinates, contains prior values and converges towards the target coordinate value determined. Advantageously, this makes it possible to obtain a much more fluid reproduction than in a reproduction according to the methods of the prior art.

According to one embodiment, the final display coordinates are determined from the target coordinates xta, xtb, yta and ytb, from prior final coordinates and from a smoothing coefficient α2 in accordance with the following formulae:

xtar=α2×xta+(1−α2)×xtar′;

xtbr=α2×xta+(1−α2)×xtbr′;

ytar=α2×xta+(1−α2)×ytar′;

ytbr=α2×xta+(1−α2)×ytbr′;

where α2 is a filtering coefficient defined empirically, and in accordance with a progressive filtering principle according to which:

Y′ᵢ=Y′ᵢ₋₁−α2(Y′ᵢ₋₁−Z′i) with Z′₀=Y′₀

where α is a smoothing coefficient defined empirically,
Y′ᵢ the smoothed (filtered) value at the instant i,
Y′ᵢ₋₁ the smoothed (filtered) value at the instant i−1,
Z′ᵢ is the value of a final display coordinate determined at the instant i.

Finally, in a step S5, the reframed portion of an image (16z, according to the example described) is resized so as to pass from a “cut” zone to a display zone and be displayed in a zone determined by the display coordinates obtained after filtering, and then the method loops back to step Si for processing the following image of the video stream 1.

According to one embodiment, the display coordinates determined correspond to a full-screen display, i.e. each of the portions of images respectively selected in an image is converted by an upscaling operation to the native format XC×YC and replaces the native image from which it is extracted in the original video stream 1 or in a secondary video stream used for a display on the display device 32.

According to one embodiment, when the target zoom factor Kc is defined using, apart from the fixed zoom factors K1 to K4, the dynamically adjustable zoom factors K1′ to K4′, the adjustment of one of the zoom factors K1′ to K4′ is implemented according to a variant of the so-called “adaptive neural gas” method, that is to say using, for each dynamically adjustable zoom factor Kn′, the allocation Kn′=Kn′+ε*e^{(-n′/λ)} (Kc−Kn′) where ε is the adjustment rate and λ the size of the neighbourhood, until one of the dynamically adjustable zoom factors is close to the target zoom factor Kc.

According to one embodiment, the videoconference system implementing the method implements an analysis of the scene represented by the successive images of the video stream 1 and records the values of the dynamically defined zoom factors by recording them with reference to information representing this scene. Thus if, at the start of a new videoconference session, the system can recognise the same scene (the same video capture environment), it can advantageously reuse without delay the zoom factors K1′, K2′, K3′ and K4′ recorded without having to redefine them. An analysis of the scenes present in video streams can be done using for example neural networks such as “Topless MobileNetV2 ” or similarity networks trained on “Triplet Loss” According to one embodiment, two scenes are considered to be similar if the distance between their embeddings is below a predetermined distance threshold.

According to one embodiment, an intermediate transmission resolution XT×YT is determined for resizing the “cut zone” before transmission, which then makes it possible to transmit the cut zone at this intermediate resolution XT×YT. According to this embodiment, the cut zone transmitted is next resized at the display resolution XD×YD.

FIG. 8 illustrates a method for dynamic adjustment of zoom factors determined in a list of so-called “dynamic” zoom factors. This method falls within the method for selecting portions of an image such as a variant embodiment of the step S2 of the method described in relation to FIG. 6. In the following description of this method, “static list” means a list of fixed, so-called “static”, zoom factors, and “dynamic list” means a list of so-called “dynamic” (adjustable) zoom factors. An initial step S20 corresponds to the definition of an ideal target zoom factor Kc from the dimensions of the bounding box, from the dimensions of the native image XC and YC, and from the current zoom factor. In a step S21, it is determined whether a satisfactory dynamic zoom factor is available, i.e. whether a zoom factor from the dynamic list is close to the ideal zoom factor Kc. To do this, two zoom factors are considered to be close to each other if their difference Kc−Kn, in absolute value, is below a predetermined threshold T. According to one example, this threshold T is equal to 0.1.

In the case where a dynamic zoom factor is found close to the ideal zoom factor Kc, this zoom factor is selected in a step S22 and then an updating of the other values of the dynamic list is implemented in a step S23, by means of a variant of the so-called neural gas algorithm. The target coordinates are next determined in the step S3 already described in relation to FIG. 6.

The variant of the neural gas algorithm is different from the latter in that it updates only the values in the list other than the one identified as being close, and not the latter.

In the case where no value in the dynamic list is determined as being sufficiently close to the ideal zoom factor Kc at the step S21, a search for the zoom factor closest to the ideal zoom factor Kc is made in a step S22′ in the two lists of zoom factors; i.e. both in the dynamic list and in the static list. In a step S23′, the dynamic list is then duplicated, in the form of a temporary list, referred to as “buffer list”, with a view to making modifications to the dynamic list, The buffer list is then updated by successive implementations, in a step S24′, of the neural gas algorithm, until the presence is obtained in the buffer list of a zoom factor value Kp satisfying the proximity constraint consisting of an absolute value of the difference Kc−Kp below the proximity threshold T. Provided that such a value Kp is obtained in the buffer list, the values of the dynamic list are replaced by the values of identical rank in the buffer list in a step S25′.

Thus, in the following iteration of the step S2 of the method depicted in relation to the level selected will be Kp.

The method next continues in sequence and the target coordinates are next determined in the step S3 already described in relation to FIG. 6.

An updating of the values of the dynamic list by means of the variant of the neural gas algorithm consists of updating, for each zoom factor in the dynamic list to be updated, an allocation Kn′=Kn′+εe(−n′/λ)(Kc−Kn′) where n′=0 indicates the factor closest to the target factor, ε is the adjustment rate and λ the size of the neighbourhood, until one of the dynamically adjustable zoom factors is sufficiently close to the target zoom factor Kc. According to one embodiment, ε and λ are defined empirically and have the values ε=0.2. and λ=1/0.05.

According to a variant embodiment, the values λ and ε are reduced as the operations progress by multiplying them by a factor of less than 1, referred to as a “decay factor”, the value of which is for example 0.995.

The modifications presented by this variant of the neural gas algorithm compared with the original algorithm lie in the fact that, when the method implements an updating of dynamic factors in the step S23 after the step S21, one of the dynamic factors is not updated. This is because the closest, which meets the condition of proximity with the target factor Kc, is not updated.

It should be noted that, according to one embodiment, a “safety” measure is applied by ensuring that a minimum distance and a maximum distance are kept between the values of each of the dynamic zoom factors. To do this, if the norm of the difference between a new calculated value of a zoom factor and a value of a neighbouring zoom factor in the dynamic list is below a predefined threshold (for example 10% of a width dimension of the native image), then the old value is kept during the updating phase.

According to a similar reasoning, if the difference between two zoom levels exceeds 50% of a width dimension of the native image, then the updating is rejected.

FIG. 7 illustrates schematically an example of internal architecture of the display device 30. We consider by way of illustration that FIG. 7 illustrates an internal arrangement of the display device 30. According to the example of hardware architecture shown in FIG. 7, the display device 30 then comprises, connected by a communication bus 3000: a processor or CPU (“central processing unit”) 3001; a random access memory (RAM) 3002; a read only memory (ROM) 3003; a storage unit such as a hard disk (or a storage medium reader, such as an SD (“Secure Digital”) card reader 3004); at least one communication interface 3005 enabling the display device 30 to communicate with other devices to which it is connected, such as videoconference devices for example, or more broadly devices for communication by communication network.

According to one embodiment, the communication interface 3005 is also configured for controlling the internal display 32.

The processor 3001 is capable of executing instructions loaded in the RAM 3002 from the ROM 3003, from an external memory (not shown), from a storage medium (such as an SD card), or from a communication network. When the display device 30 is powered up, the processor 3001 is capable of reading instructions from the RAM 3002 and executing them. These instructions form a computer program causing the implementation, by the processor 3001, of all or part of a method described in relation to FIG. 6 or variants described of this method.

All or part of the methods described in relation to FIG. 6, or variants thereof described, can be implemented in software form by executing a set of instructions by a programmable machine, for example a DSP (“digital signal processor”), or a microcontroller, or be implemented in hardware form by a machine or a dedicated component, for example an FPGA (field-programmable gate array) or an ASIC (application-specific integrated circuit). Furthermore, at least one neural accelerator of the NPU type can be used for all or part of the calculations to be done. In general, the display device 30 comprises electronic circuitry configured for implementing the methods described in relation to it. Obviously, the display device 30 further comprises all the elements usually present in a system comprising a control unit and its peripherals, such as a power supply circuit, a power-supply monitoring circuit, one or more clock circuits, a reset circuit, input/output ports, interrupt to inputs and bus drivers. This list being non-exhaustive.

1. A method for selecting portions of images to be reproduced, from a video stream comprising a plurality of images each comprising a representation of a subject, the method comprising the steps of:
determining limits of a first portion of an image comprising the subject,
determining a target zoom factor among a plurality of zoom factors from the limits, a current zoom factor and at least one maximum resolution of the images,
determining target coordinates of a second portion of an image, representing the subject, obtained from the first portion of an image, by a reframing implemented according to the target zoom factor determined and from the at least one maximum resolution.

2. The method for selecting portions of an image according to claim 1, the method furthermore comprising, subsequently to the step of determining target coordinates:
a determination of display coordinates of the second portion of an image from the target coordinates and prior display coordinates used for a display of a third portion of an image on a display, and
a display of the second portion of an image on the display.

3. The method for selecting portions of an image according to claim 2, wherein the determination of display coordinates of a second portion of an image comprises a time filtering implemented using a plurality of prior display coordinates used for a display of portions of images.

4. The method for selecting portions of an image according to claim 1, wherein the determination of a target zoom factor is implemented using a hysteresis mechanism.

6. The method for selecting portions of an image according to claim 1, further comprising a use of a plurality of second zoom factors and comprising a modification of at least one of the second zoom factors in the plurality of second zoom factors according to at least the target zoom factor.

7. The method for selecting portions of images according to claim 6, wherein the modification of at least one of the second zoom factors uses a method for modifying a series of data according to a variant of the so-called “Adaptive Neural Gas” algorithm.

8. A nontransitory information storage medium storing a computer program product, wherein the computer program product comprises program code instructions for executing the steps of the method according to claim 1, when the program is executed by a processor.

9. (canceled)

10. A system for selecting portions of images comprising an interface for receiving a video stream comprising a plurality of images each comprising a representation of a subject, and electronic circuits configured for:
determining limits of a first portion of an image comprising the subject,
determining a target zoom factor among a plurality of zoom factors from the limits, a current zoom factor and at least one maximum image resolution,
determining target coordinates of the first portion of an image reframed implemented according to the target zoom factor determined and the at least one maximum image resolution.

11. The system for selecting portions of images according to claim 10, further comprising electronic circuits configured to:
determine display coordinates of a second portion of an image, representing the subject, obtained by a reframing implemented according to the target zoom factor, the target coordinates and prior display coordinates used for a display of a third portion of an image on a display, and
reproducing the second portion of an image on a display.

12. A videoconference system comprising a system for selecting portions of images according to claim 10.
